(19) United States
(12) Patent Application Publication
(10) Pub. No.: US 2004/0163458 A1
(43) Pub. Date: Aug. 26, 2004

(54) Portable golf flag device and method therefor

(76) Inventor: Alan J. Lapkin, Las Vegas, NV (US)

Correspondence Address: WEISS & MOY PC, 4204 NORTH BROWN AVENUE, SCOTTSDALE, AZ, 85251, US

(21) Appl. No.: 10/372,334

(22) Filed: Feb. 24, 2003

(51) Int. Cl. G01W 1/00

(52) U.S. Cl. 73/170.05

(57) ABSTRACT

A portable golf flag device and method therefor capable of being coupled to a golf cart, golf bag or other object and able to determine the direction and velocity of wind. The portable golf flag comprises a coupling mechanism, preferably a clamp, coupled at one end and capable of coupling the portable golf flag to an object.

### FIELD OF THE INVENTION

This invention relates generally to golf flags and, more specifically, to a portable golf flag device capable of determining the direction and velocity of wind and capable of being attached to a golf cart, golf bag or other object.

### BACKGROUND OF THE INVENTION

The game of golf is both a popular sport as well as a common recreational activity throughout the world. As an outdoor sport, wind can play a critical part in the performance of a golfer. It is for this reason that flags are placed at the top of the pin that designates the cup of each golf hole. In this way, golfers often judge the direction and strength of wind by looking out to the flag ahead. On long holes, particularly par 4 and par 5 holes, it is often difficult for a golfer to actually see the flag on top of the pin to determine the direction and velocity of wind. Even when a player is close to a hole, if the pin is obstructed by a hill, tree or other object, it can often be difficult for a player to determine which direction the wind is blowing. Even when the flag of the golf pin is clearly visible, a player is only able to determine the direction and velocity of wind on the green, which may be quite different from the direction and velocity of the wind where the player is about to strike his or her golf ball.

Therefore, a need existed for a portable golf flag device, capable of being attached to a golf cart, golf bag, or other object so that a golfer can easily assess the direction and degree of wind at the location from which the golfer will strike the golf ball.

### SUMMARY OF THE INVENTION

An object of the present invention is to provide a portable golf flag device for determining the direction and strength of wind and dimensioned to be coupled to a golf bag, golf cart or other object.

It is a further object of the present invention to provide a method for determining the direction and velocity of wind by providing a portable golf flag device and coupling it to a golf cart, golf bag or other object.

### BRIEF DESCRIPTION OF THE PREFERRED EMBODIMENTS

In accordance with one embodiment of the present invention, a portable golf flag device is disclosed, comprising, in combination, a pole having a first end and a second end, a flag coupled to the first end of the pole, and a coupling mechanism coupled to the second end of the pole and dimensioned to couple the pole to an object.

In accordance with another embodiment of the present invention, a method for determining wind direction and velocity is disclosed, comprising, in combination, the steps of providing a pole having a first end and a second end, providing a flag coupled to the first end of the pole, providing a coupling mechanism coupled to the second end of the pole, and coupling the coupling mechanism to an object.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a front view of one embodiment of the portable golf flag device of the present invention, showing the flexible cable coupled to the clamp.

FIG. 2 is a front view of one embodiment of the portable golf flag device of the present invention, showing the flexible cable detached from the pole of the portable golf flag device.

FIG. 3 is a front view of the bottom portion of the pole of one embodiment of the golf flag device of the present invention, showing a clamp coupled to the bottom portion of the pole through a ring and chain combination.

FIG. 4 is a front view of the flexible cable of the portable golf flag device of the present invention.

FIG. 5 is a front view of the pole of the portable golf flag device, showing the pole telescopically extended.

### DETAILED DESCRIPTION OF THE PREFERRED EMBODIMENTS

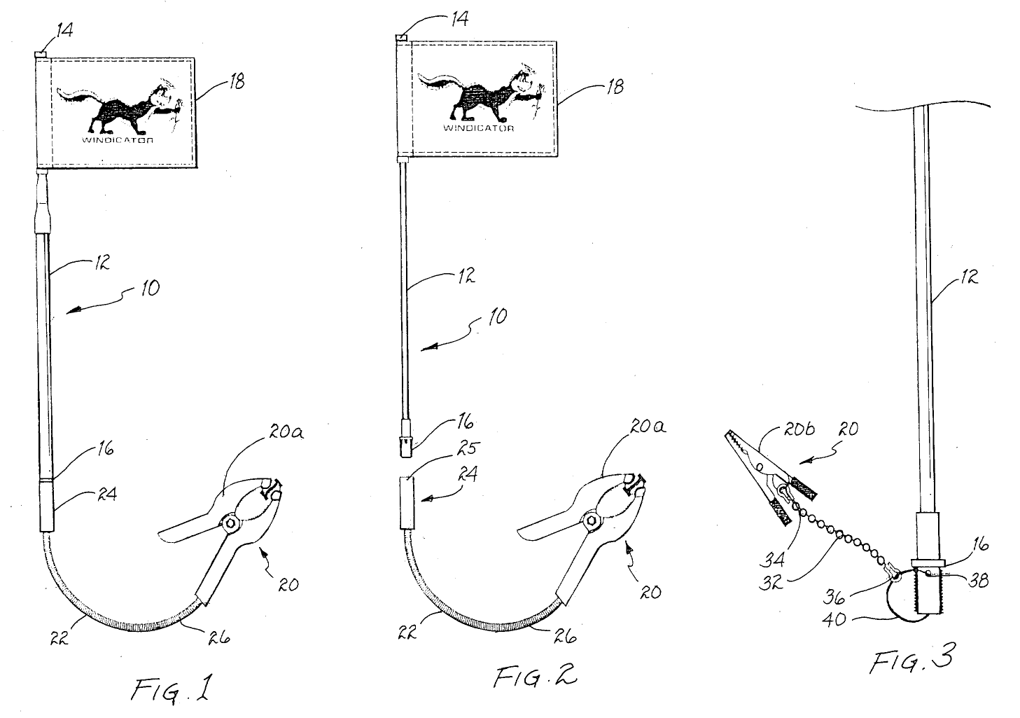

Referring now to FIGS. 1 and 2 reference number 10 refers generally to the portable golf flag device of the present invention. The device 10 comprises a pole 12 (also shown in FIGS. 3 and 5) having a first end 14 and a second end 16. The device 10 further comprises a flag 18 (shown in FIGS. 1, 2 and 5). The flag 18 is coupled to the first end 14 of the pole 12. The portable golf flag device 10 further comprises a coupling mechanism, referred to generically as coupling mechanism 20, coupled to the second end 16 of the pole 12 and dimensioned to couple the pole 12 to an object.

Referring specifically to FIGS. 1-2, one embodiment of the portable golf flag device 10 comprises a clamp 20a as the coupling mechanism 20. Preferably, the clamp 20a is a heavy-duty-type, spring-biased, clamp capable of clamping onto an object, such as a golf cart, while at the same time supporting the pole 12 and the flag 18 in a substantially vertical, upright position. It should be clearly understood, however, that substantial benefit could be derived from an alternative configuration of the coupling mechanism 20 in which a device other than a clamp 20a is used, so long as it is capable of coupling the pole 12 securely to an object in a substantially vertical position.

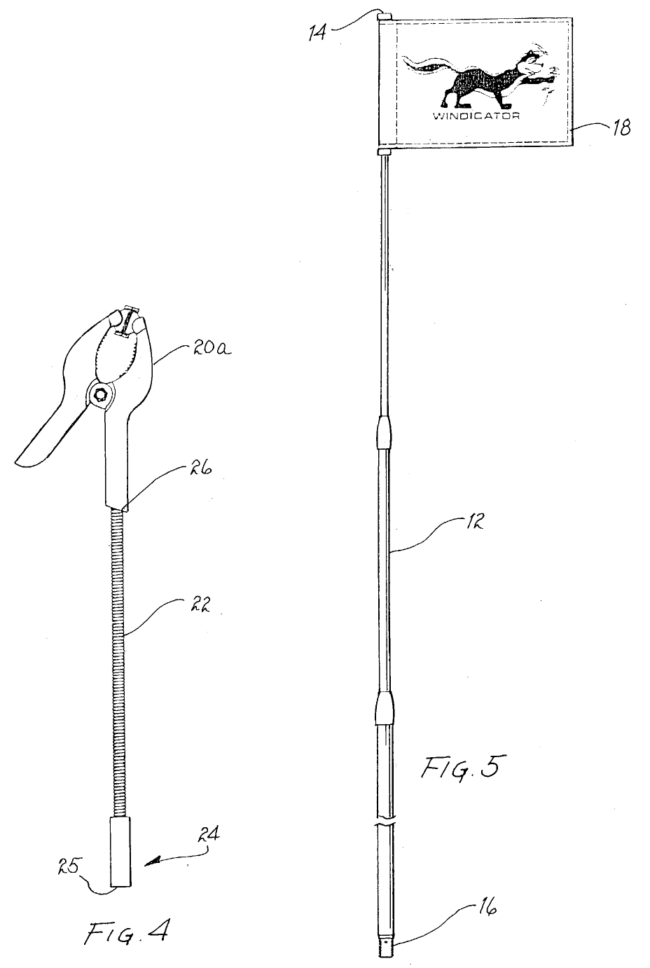

Referring now to FIGS. 1, 2 and 4, in one embodiment, the portable golf flag device 10 further comprises a flexible cable 22 having a first end 24 and a second end 26. The first end 24 of the flexible cable 22 is coupled to the second end 16 of the pole 12. The second end 26 of the flexible cable 22 is coupled to the clamp 20a. Preferably, the clamp 20a and the flexible cable 22 are fixedly coupled to one another, forming a one-piece assembly, although it should be clearly understood that substantial benefit could be derived from an alternative embodiment of the present invention in which the second end 26 of the flexible cable 22 is detachably coupled to the clamp 20a. The flexible cable 22 preferably has sufficient flexibility to be bent between the first end 24 and the second end 26 while at the same time the flexible cable 22 has sufficient rigidity to remain in a fixed position after the flexible cable 22 is bent. Preferably, the second end 16 of the pole 12 is threaded and the first end 24 of the flexible cable 22 defines a threaded sleeve 25 dimensioned to be coupled to the threaded second end 16 of the pole 12, although it should be clearly understood that substantial benefit could be derived from an alternative means of coupling the first end 24 of the flexible cable 22 to the second end 16 of the pole 12, such as a spring-biased ball detent, so long as the flexible cable 22 is securely coupled to the pole 12.

Referring now to FIG. 3, an alternative coupling mechanism 20, hereinafter gripper 20b, is shown. The gripper 20b is preferably coupled to a first end 34 of a chain 32. A second end 36 of the chain 32 is coupled preferably to the second end 16 of the pole 12. Preferably, the second end 36 of the chain 32 is coupled to the second end 16 of the pole 12 through an aperture 38 defined by said second end 16 of the pole 12. In one embodiment, shown in FIG. 3, a ring 40 is coupled to the second end 16 of the pole 12 through the aperture 38 and the second end 36 of the chain 32 is coupled to the ring 40, although it should be clearly understood that substantial benefit could be derived from an alternative embodiment of the portable golf flag device 10 in which there is no ring 40, or in which the gripper 20b is coupled to the second end 16 of the pole 12 without a chain 32, so long as the gripper 20b is capable of being securely coupled to the pole 12. The gripper 20b is designed to couple the pole 12 to an object, such as a golf bag, in which it is not necessary for the pole 12 to be held in an upright position. The purpose of the gripper 20b is to simply couple the portable golf flag device 10 to another object, after which time, a person would simply hold the pole 12 in an upright position in order to determine wind direction and velocity. The clamp 20a, on the other hand, is dimensioned to hold the pole 12 in a substantially vertical position without the need to be held by a person in order to allow a person to couple the portable golf flag device 10 to an object, such as a golf cart, and thereafter be able to determine wind direction and velocity.

While the invention has been particularly shown and described with reference to preferred embodiments thereof, it will be understood by those skilled in the art that the foregoing and other changes in form and details may be made therein without departing from the spirit and scope of the invention. For example, in addition to golf applications the portable golf flag device of this invention could be used for other applications in which it is beneficial to determine wind direction and velocity, such as fly fishing, kicking field goals in football, etc.

I claim:

1. A portable golf flag device comprising, in combination:
a pole having a first end and a second end;
a flag coupled to said first end of said pole; and
a coupling mechanism coupled to said second end of said pole and dimensioned to couple said pole to an object.

2. The portable golf flag device of claim 1 wherein said coupling mechanism is a clamp.

3. The portable golf flag device of claim 2 wherein said clamp being spring-biased.

4. The portable golf flag device of claim 2 further comprising a flexible cable having a first end and a second end, said first end of said flexible cable being coupled to said second end of said pole and said second end of said flexible cable being coupled to said clamp, said flexible cable has sufficient flexibility to be bent between said first end and said second end while at the same time said flexible cable has sufficient rigidity to remain in a fixed position after said flexible cable is bent.

5. The portable golf flag device of claim 4 wherein said second end of said pole being threaded and said first end of said flexible cable defining a threaded sleeve dimensioned to be coupled to said threaded second end of said pole.

6. The portable golf flag device of claim 1 wherein said pole being telescopically extendable from said second end to said first end.

7. The portable golf flag device of claim 1 further comprising a chain having a first end and a second end, said first end of said chain being coupled to said second end of said pole and said second end of said chain being coupled to said clamp.

8. The portable golf flag device of claim 7 wherein said first end of said chain being coupled to said second end of said pole through an aperture defined by said second end of said pole.

9. The portable golf flag device of claim 1 wherein said object is a golf cart.

10. The portable golf flag device of claim 1 wherein said object is a golf bag.

11. A method for determining wind direction and velocity comprising, in combination, the steps of:
providing a pole having a first end and a second end;
providing a flag coupled to said first end of said pole;
providing a coupling mechanism coupled to said second end of said pole; and
coupling said coupling mechanism to an object.

12. The method of claim 11 wherein said coupling mechanism is a clamp.

13. The method of claim 12 wherein said clamp being spring-biased.

14. The method of claim 12 further comprising the steps of:
providing a flexible cable having a first end and a second end; and
coupling said first end of said flexible cable to said second end of said pole, said second end of said flexible cable being coupled to said clamp, said flexible cable has sufficient flexibility to be bent between said first end and said second end while at the same time said flexible cable has sufficient rigidity to remain in a fixed position after said flexible cable is bent.

15. The method of claim 14 wherein said second end of said pole being threaded and said first end of said flexible cable defining a threaded sleeve dimensioned to be coupled to said threaded second end of said pole.

16. The method of claim 11 further comprising the step of telescopically extending said pole from said first end to said second end.

17. The method of claim 11 further comprising the steps of:
providing a chain having a first end and a second end;
coupling said first end of said chain to said second end of said pole; and
coupling and said second end of said chain to said clamp.

18. The method of claim 17 further comprising the step of coupling said first end of said chain to said second end of said pole through an aperture defined by said second end of said pole.

19. The method of claim 11 wherein said object is a golf cart.

20. The method of claim 11 wherein said object is a golf bag.
